(19) United States
(12) Patent Application Publication
(10) Pub. No.: US 2004/0182370 A1
(43) Pub. Date: Sep. 23, 2004

(54) Electrically heated throttle body

(75) Inventors: Timothy M. Parkinson, Canton, MI (US); Mark D. Conley, Westland, MI (US); Aniruddha Karve, Ypsilanti, MI (US); Thomas R. Goodhue, ypsilanti, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/390,467

(22) Filed: Mar. 17, 2003

(51) Int. Cl. F02G 5/00

(52) U.S. Cl. 123/549

(57) ABSTRACT

The present invention provides an improved throttle assembly for an internal combustion engine in an automotive vehicle. The throttle assembly includes a housing having a bore and a rotating throttle plate within the bore. A shaft connected to the plate allows the plate to pivot within the bore. A heating element is integrally formed in the throttle housing. By applying voltage to the heating element, the element heats the housing and thereby prevents the formation of ice in the throttle bore ensuring that the throttle plate can freely rotate under all engine operating conditions.

### BACKGROUND

1. Technical Field

This invention relates generally to a throttle assembly and, more specifically, to a heated throttle body for an internal combustion engine in an automotive vehicle.

2. Description of the Related Art

A throttle assembly controls airflow to a vehicle's engine. A typical throttle assembly consists of a throttle plate connected to a shaft assembly that allows the plate to rotate in a throttle housing bore. A driver operated cable or motor controls the rotation of the throttle plate thus controlling the amount of airflow entering the engine.

Under certain conditions, ice can form in the throttle bore. The formation of ice can restrict the throttle plate such that the plate does not have its intended full range of motion. Regardless of the vehicle operating conditions, the throttle plate must rotate freely so that airflow to the engine can be stopped at any time.

There are several known systems used to prevent the formation of ice in the throttle bore. In general, these systems heat the throttle housing.

One known system uses water from the engine coolant system to heat the throttle body. Heating throttle bodies by use of liquids requires a relatively complex and expensive set of hoses, tubes, and clamps to complete the circuit to and from the throttle body. Special machining operations on the throttle housing are also required to form the liquid circuit.

Another known system uses an electrical heating element inserted into bores and grooves that are machined into the throttle housing. A disadvantage of this system is less flexibility regarding the placement of the heating element due to machining limitations.

In view of the above and other disadvantages, there exists a need for an improved heated throttle assembly for an internal combustion engine.

### SUMMARY OF INVENTION

The present invention overcomes the disadvantages of prior designs by providing a less complex heated throttle assembly for an internal combustion engine.

The throttle assembly of the present invention includes a throttle housing having a central bore, a throttle plate positioned within the bore and pivotable between a closed position and an open position, a shaft assembly connected to the throttle plate for allowing pivotal motion of the plate within the bore, and a heating element integral with the throttle housing in close proximity to the throttle plate.

The use of an integral electrically powered resistive element to heat the throttle housing offers several advantages over known systems. Since the present invention requires only the resistive element, wiring and wiring connectors, the system is not complex, has a small number of parts and the overall cost is lower. The electrically heated throttle body offers a smaller overall package envelope. This allows manufacturers to package this feature into existing vehicles more easily. With an electrically heated throttle body, the engine coolant system has no additional penetrations into the system, so the chance of a coolant leak as a result thereof is eliminated.

These and other aspects and advantages of the present invention will become apparent upon reading the following detailed description of the invention in combination with the accompanying drawings.

### BRIEF DESCRIPTION OF THE DRAWING

FIG. 1 is a schematic view of the throttle assembly of the present invention illustrating the heating element in the throttle body; and

FIG. 2 is an elevational view of the heating element seen in FIG. 1.

### DETAILED DESCRIPTION OF THE INVENTION

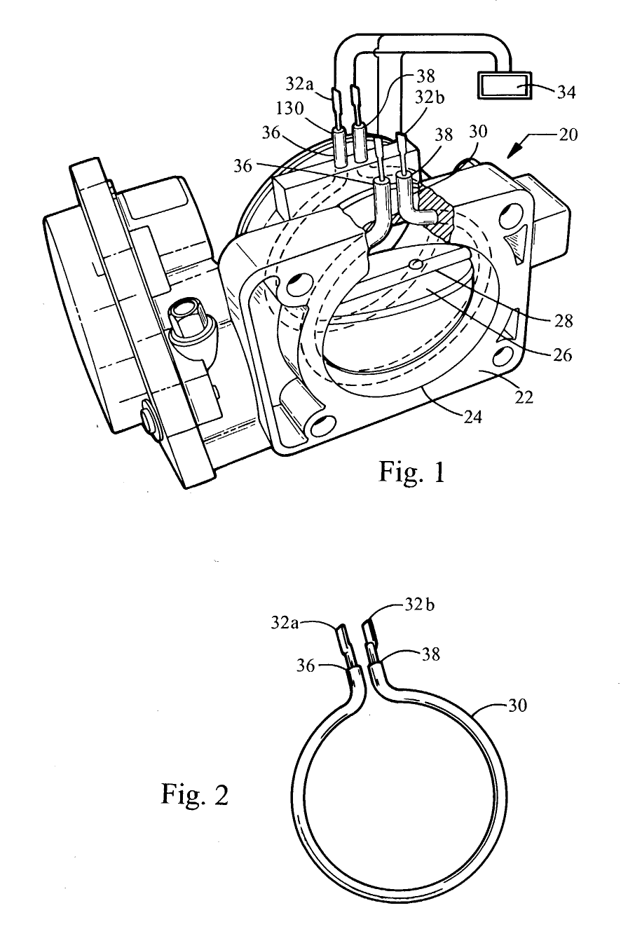

FIG. 1 generally illustrates the throttle assembly 20 of the present invention. The throttle assembly 20 is positioned in a vehicle (not shown) that has an internal combustion engine (not shown), typically between the air cleaner and the intake plenum. The throttle assembly 20 controls the amount of air entering the internal combustion engine through the intake manifold. As its principle components, the throttle assembly 20 includes a housing 22 having a bore 24, a throttle plate 26 positioned within the bore 24, a shaft assembly 28 connected to the throttle plate 26 and the housing 22 that allows the plate 26 to pivot within the bore 24, and a heating element 30 formed integrally with the throttle housing 22.

The throttle housing bore 24 and plate 26 are both generally circular in shape, with plate 26 being in a relatively close fit relation to the bore 24. The throttle plate 26 has pivotable motion ranging from a closed position to an open position. When the throttle plate is in the closed position it is completely obstructing airflow through the bore and in the open position it is minimally obstructing airflow through the bore.

In general, the heating element 30 is a resistive heating element that can be formed and contoured. This allows the element 30 to be placed where it is most effective at eliminating ice formation in the throttle bore 24. Preferably, the heating element 30 has a first end 36 coupled to a second end 38 by a central loop portion 39 illustrated in FIG. 2 generally as a circular loop.

Also preferably, a first electrical connector 32A is attached to the first end 36 of the heating element and a second electrical connector 32B is attached to the second end 38 of the heating element. The electrical connectors 32 are used to connect, via wires 33A and 33B, to a power source 34. When exposed to a voltage from the power source 34, the heating element 30 produces heat. Obviously, the power source could be, but is not limited to, the vehicle's battery or the vehicle's power control module (“PCM”).

During the manufacturing process, which is preferably a die casting process, the heating element 30 is formed into a predetermined shape and held in an appropriate position within a mold used to form the housing 22. The preferred position for the heating element 30 is proximate to the throttle plate 26. Finally, metal is flowed into the mold and solidified, forming the housing 22 with the heating element 30 integral therein. The heating element 30 is encased by the throttle housing material with only the first and second ends 36, 38 of the heating element located external of the housing 22.

The heating element 30 can be manufactured such that it delivers more heat to specific locations along its length. This allows the heat to be concentrated in certain areas of the throttle bore 24 where it is most effective at eliminating ice formation.

In an alternative embodiment, multiple heating elements can be incorporated into the housing 22 to increase the amount of heat available to prevent icing and further improving effectiveness. One such alternative includes a second heating element 130 integrally formed with the throttle housing 22 surrounding the central bore 24.

When the above described assembly 20 is used in a vehicle with a forty-two (42) volt electric system (as opposed to a typical 12 volt system), the amount of power delivered to the throttle housing can be greatly increased due to the higher amount of electric power available. This large amount of power offers the opportunity to eliminate one failure mode that cannot be addressed with liquid heated throttle body assemblies. This failure mode concerns an iced throttle body that occurs after an extended vehicle shutdown.

After an extended vehicle shutdown, the engine coolant temperature decreases to ambient. Once engine startup has occurred, it takes several minutes to reach a coolant temperature at which heat is transferred to the throttle bore. Accordingly, there is a delay of several minutes before any ice in the throttle bore is melted. To the contrary, with an electrically heated throttle housing heat can be delivered to the throttle bore soon after the vehicle is started, resulting in any ice present in the bore being melted more quickly.

As a person skilled in the art of internal combustion engine systems will recognize from the previous detailed description and from the figures and claims, modifications and changes can be made to the preferred embodiments of the invention without departing from the scope of this invention defined in the following claims.

1. A throttle assembly comprising:
a throttle housing having portions defining a bore;
a throttle plate positioned within said housing bore and pivotable between a closed position and an open position; and
a heating element integrally formed with said throttle housing, said heating element at least partially encircling said bore.

2. The throttle assembly of claim 1 wherein said heating element surrounds said bore proximate to said throttle plate.

3. The throttle assembly of claim 1 further comprising a shaft assembly connected to said throttle plate and said housing for allowing pivotal motion of said throttle plate within said central bore.

4. The throttle assembly of claim 1 wherein said bore is generally circular.

5. The throttle assembly of claim 1 wherein said throttle plate is generally circular.

6. The throttle assembly of claim 1 further comprising a second heating element formed integrally with said throttle housing and surrounding said central bore.

7. The throttle assembly of claim 1 wherein said heating element is generally circular.

8. The throttle assembly of claim 1 wherein said heating element is rigid.

9. The throttle assembly of claim 1 wherein said throttle housing including said integral heating element is formed by a die casting process.

10. The throttle assembly of claim 1 wherein said heating element includes a first end and a second end extending from said housing.

11. The throttle assembly of claim 10 further including an electrical connector attached to each of said first and second ends.

12. The throttle assembly of claim 1 further including a power source connected to said heating element.

13. The throttle assembly of claim 1 wherein said heating element is a resistive heating element.

14. The throttle assembly of claim 1 wherein said heating element includes a first end, a second end and central portion between said first and second ends, said central portion substantially encircling said bore.

15. The throttle assembly of claim 14 wherein said central portion is generally circular.
